(19) United States
(12) Patent Application Publication
(10) Pub. No.: US 2008/0216738 A1
(43) Pub. Date: Sep. 11, 2008

(54) Ultimate cove corner tool

(76) Inventor: Larry Mont Monroe, Kalispell, MT (US)

Correspondence Address: Larry Mont Monroe, 150 Shady Lane # 189, Kalispell, MT, 59901, US

(21) Appl. No.: 11/714,318

(22) Filed: Mar. 6, 2007

(51) Int. Cl. B05C 1/00

(52) U.S. Cl. 118/200

(57) ABSTRACT

A ultimate cove corner tool is provided for use in applying plaster material or a drywall taping compound to an inside corner joint between drywall panels to form a controlled and smoothly radiused surface. The tool includes a tool head in the form of a forwardly open resilient cup carried at a forward end of a tool handle, wherein the cup is adapted to support a quantity of the plaster or a drywall taping compound as the handle is manipulated to press and spread the plaster material or a drywall taping compound inside corner joint. The resilient cup deforms upon engagement with the drywall panels at the corner joint to spread the plaster material or a drywall taping compound material with a desired and smoothly radiused surface. The specific radiused geometry of the plaster material or a drywall taping compound surface in variably controlled by varying the orientation of and manual pressure applied to the resilient cup. At the end of the handle are threads which a person can screw a paint pole onto to give added length to the handle for reaching the higher inside corner joints between the drywall panels.

### BACKGROUND OF THE INVENTION

This invention relates generally to tools and related methods of use for applying plaster material or a drywall taping compound to an inside corner joint between adjacent drywall panels in a building. More specifically, this invention relates to an improved and easy-to-use Cove Corner Tool for spreading plaster or a drywall taping compound along an inside corner joint with a smoothly rediused and variably selected surface geometry.

Drywall panels of plaster-board material of the like are used extensively in residential and commercial construction projects to form interior walls within a building structure. In accordance with common construction techniques, the drywall panels are securely mounted onto frame components such as wall studs. Thereafter, joints formed between adjacent drywall panels are taped and filled with plaster material or a drywall taping compound to form a desired smooth and substantially uninterrupted wall surface.

The process of taping and filling exposed joints between adjacent drywall panels involves substantial manual labor and considerable skill to provide the desired smooth and attractive wall surface. In this regard, particular difficulties are encountered in filling an inside angle corner joint. More specifically, plaster material or a drywall taping compound is pressed into and spread along the inside corner joint in an effort to form a smoothly radiused corner surface if substantially continuous cross-sectional geometry for the entire length of the corner joint. Variations in a radiused inside corner, involving fluctuations in sharpness of the corner contour, can be particularly unsightly.

In the past, various manual tools have been provided for use by construction workers in the taping and filling of joints between drywall panels. Some of these have been adapted for applying plaster materials to an inside corner joint, and in a manner providing a substantially uniform radiused surface at the corner joint. Such tools, however, have included rigid tool heads for spreading the plaster material with a fixed surface geometry, within an inside corner of fixed angular shape, for example, a ninety-degree corner. Prior coved corner radius tools have not provided the ability to selectively vary the geometry of a smoothly radiused plaster material or drywall taping compound surface at an inside corner joint, nor have such prior tools been capable of forming a smoothly radiused surface on an inside corner joint formed at an angle other than ninety degrees.

The present invention overcomes the problems and disadvantages encountered in the prior art of dry-walling, by providing an improved Ultimate Cove Corner Tool for applying plaster material or drywall taping compound to an inside corner joint between adjacent drywall panels, wherein a smoothly radiused corner surface of variable selected geometry can be formed quickly and easily at an inside corner of virtually any angle.

### SUMMARY OF THE INVENTION

In accordance with the invention, a Ultimate Cove Corner Tool is provided for applying plaster material or drywall taping compound between adjacent drywall panels in a building structure. The improved Ultimate Cove Corner Tool includes a resilient tool head for supporting a quantity of the plaster material as the tool head is pressed into and moved into and moved along an inside corner joint. The tool head deforms against the drywall panels at the corner joint and is shaped when deformed to define a trailing edge of selected geometry for spreading the plaster material or drywall taping compound with a smoothly radiused surface as the tool head is drawn along the corner joint. The specific geometry of the radiused surface is variably selected by the orientation of the tool head relative to the Ultimate Cove Corner Tool and manual pressure applied to the tool head. By drawing the tool head along the corner joint at substantially constant orientation and pressure, a smoothly radiused former surface of uniform cross-sectional shape is formed.

In accordance with the preferred form of the invention, the improved Ultimate Cove Corner Tool comprises a manually grasped handle having a tool shank projecting forwardly therefrom. The tool head comprises a resilient cup mounted at a forward end of the tool shank, wherein the resilient cup defines a forwardly presented concave cup interior for receiving a quantity of the plaster material or drywall taping compound. In the preferred form, the forward end of the tool shank includes a bend for supporting the resilient cup at an angle of about 30. Degree to a longitudinal axis of the tool handle. In addition, diametric cup sizes on the order of about two to four inches are preferred.

In use, the Ultimate Cove Corner Tool can be used to scoop a quantity of plaster or drywall taping compound into the concave resilient cup. The plaster or drywall taping compound is pressed into and inside corner joint, and drawn along the joint in either direction while maintaining the resilient cup at a substantially constant orientation and under substantially constant manual pressure.

Other features and advantages of the invention will become more apparent from the following detailed description, taken in conjunction with the accompanying drawings which illustrate, by the way of example, the principles of the invention.

### BRIEF DESCRIPTION OF DRAWINGS

The accompanying drawings illustrating the invention. In such drawings:

FIG. I: is a perspective view illustrating us of the Ultimate Cove Corner Tool embodying the novel features of the invention for applying plaster material or a drywall taping compound to an inside corner joint between adjacent drywall panels;

FIG. II: is an enlarged fragmented horizontal sectional view taken generally on the line 2-2 of FIG. 1;

FIG. III: is an enlarged perspective view illustration the Ultimate Cove Corner Tool of FIG. 1;

FIG. IV: is a fragmented side elevated view, shown partially in vertical section, illustrating use of the tool for scooping a quantity of plaster material or a drywall taping compound from a hand held tray;

FIG. V: is a fragmented perspective view similar to FIG. 1, but illustrating upward movement of the Ultimate Cove Corner Tool along an inside corner joint;

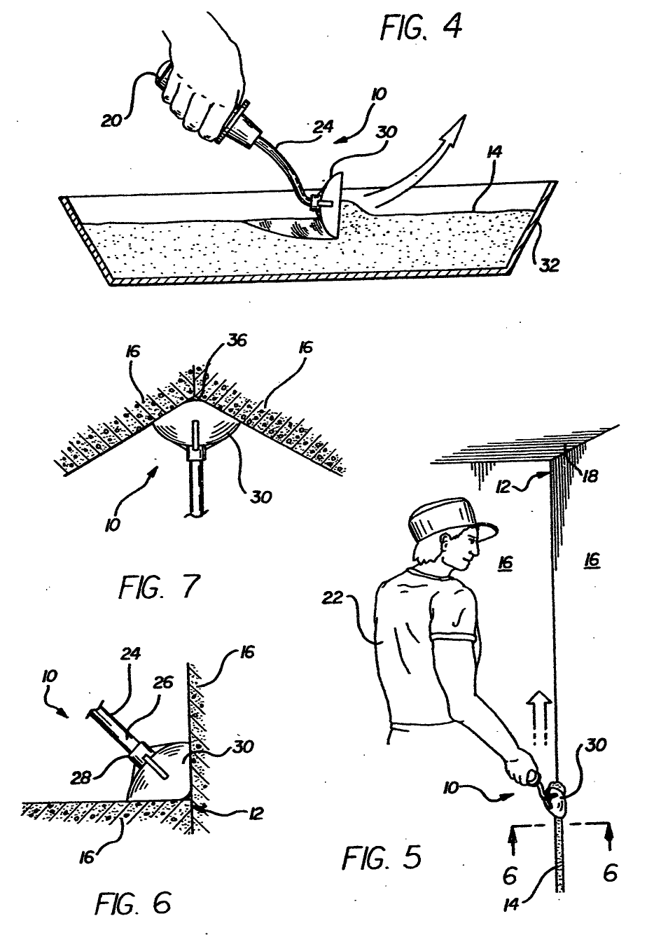

FIG. VI: is an enlarged fragmented horizontal section view taken generally on the line 6-6 of FIG. 5;

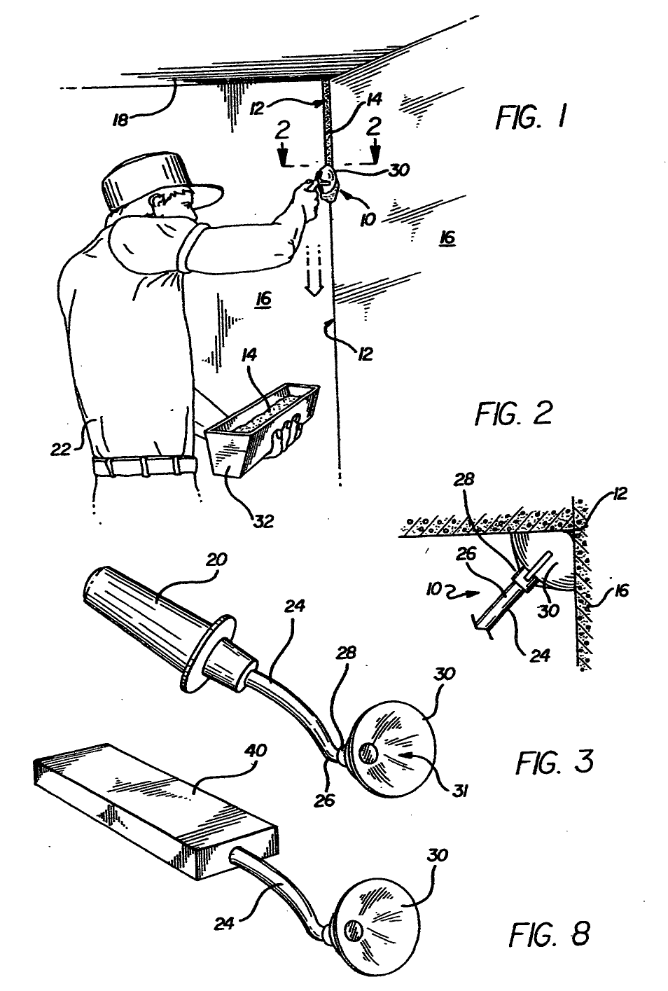

FIG. VII: is an enlarged fragmented horizontal sectional view similar to FIGS. 2 and 6, but illustrating use of the tool for applying plaster material or a drywall taping compound to an inside corner joint of different angle; and

FIG. VIII: is a perspective view illustrating an alternative preferred form of the invention.

### DETAILED DESCRIPTION OF THE PREFERRED EMBODIMENTS

As shown on the exemplary drawings, a Ultimate Cove Corner Tool referred to generally by the reference numeral 10 is provided for filling an inside corner joint 12 with a plaster material or drywall taping compound 14 or the like to define a smoothly radiused corner surface, as viewed, as viewed in FIG. 1. The inside corner joint 12 is formed at the intersection of adjacent drywall panels 16. Appropriate orientation and manipulation of the corner radius tool 10 provides easily varied selection of the geometry of the radius corner surface. Moreover, the tool 10 may be used for filling inside cornerjoints of virtually any angle.

FIG. 1 illustrates use of the Ultimate Cove Corner Tool 10 of the present invention for filling a vertical inside corner joint 12 having an angle of about 90 degree.

FIG. 2 an extending between the ceiling 18 and floor (not shown) of a room within a building structure. In this regard, the drywall panels 16 are commonly used to define interior walls of a residential or commercial building structure. In the construction process, the inside corner joint 12 is filled with the plaster material or drywall taping compound 14 to form an attractive and smoothly radiused corner surface which blends smoothly and substantially continuously with the broad surfaces of the drywall panels 16. Additional inside corner joints, such as those shown in FIG. 1 to extend along the tops of the panels 16 and the ceiling panel 18 are also filled with plaster material or drywall taping compound, preferably with the use of the improved Ultimate Cove Corner Tool of the present invention.

The Plaster material 14 is normally mixed with water and a supply thereof is carried by the workman 22 in a hand-held tray 32. The tool 10 is easily maneuvered to scoop a quantity if the plaster material or drywall taping compound 14 into a concave interior 31 of the resilient cup 30. The tool head carrying the plaster material or drywall taping compound 14 is then pressed into the selected inside corner joint 12, while holding the resilient cup at a selected orientation and pressing toward the corner joint with a selected manual pressure. The resilient cup 30 deforms against the drywall panels 16 to reshape a trailing edge of the cup into a smoothly radiused surface for spreading the plaster material along the corner joint. FIGS. 1 and 2 show downward displacement of the tool 10 along the corner joint to spread the plaster material or drywall taping compound, whereas FIGS. 5 and 6 show upward displacement of the tool. In either case, a smoothly radiused corner surface of the selected geometry, according to took head orientation and manual pressure, is archived. In general terms, increased manual pressure is applied to the tool head causes greater deformation of the cup 30 and thus forms the plaster material or drywall taping compound with a sharper corner line.

FIG. 7 shows the Ultimate Cove Corner Tool 10 applied to an inside former joint 36 of different angle, namely, an angle of about 120.degree. Once again, manual pressure applied to the tool head in a direction toward the corner, in combination with tool head orientation, provides a smoothly contoured and highly uniform radiused surface geometry as the tool is drawn along the corner joint to spread the plaster material or drywall taping compound.

FIG. 8 shows one alternative embodiment of the invention, wherein a modified handle 40 is mounted on the tool shank 24. The modified handle 40 has a rectangular cross-sectional geometry, whereby planar surfaces of the handle can be manually perceived by the workman to assist in maintaining a constant tool has orientation relative to a corner joint, as the implement is drawn along the corner joint to apply the plaster material or drywall taping compound.

The improved Ultimate Cove Corner Tool 10 of the present invention thus provides a versatile yet easy-to-use implement for applying and spreading plaster material or a drywall taping compound with a smoothly radiused and substantially constant geometry along an inside corner joint of a building wall. The tool 10 can be used to form smoothly radiused corner joint surfaces at inside corners of different angles, and /or with different corner joint configurations, in accordance with the manner and orientation of tool use. Importantly, uniform and attractive corner joint surfaces can be formed quickly and easily, and without requiring extensive workman skill or training.

A variety of modifications and improvements to the Ultimate Cove Corner Tool of the present invention is intended by way of the foregoing description and accompanying drawings, except as set forth in the appended claims.

What is claimed is:

1. An Ultimate Cove Corner Tool is used for filling an inside corner joint of a wall with a plaster or drywall taping compound to form a smoothly radiused corner surface, said tool comprising:
a tool handle adapted for manual grasping and defining a forward end also with a threaded female receptacle adapted end for the purpose of attaching an extended paint pole handle, allowing the user to reach a taller ceiling from the floor;
a tool head formed from a resilient material and having a generally cup-shaped geometry to define a generally concave cup interior; and
means for supporting said tool head at said interior being presented generally in a forward outwardly facing direction away from said supporting means, whereby said tool head can be pressed into an inside corner joint at a selected manual pressure and drawn along said inside corner joint at a selected orientation to spread plaster material or drywall taping compound within said cup interior along said inside corner joint to form the smoothly radiused corner surface.

2. The Ultimate Cove Corner Tool of claim 1 wherein said tool head supporting means comprises a tool shank connected between said handle and said tool head.

3. The Ultimate Cove Corner Tool of claim 2 wherein said tool shank supports said a cup at an angle of about thirty degrees with respect to a longitudinal axis of a said tool handle. The said tool shank also helps support the paint pole handle when attached to the tool handle threads.

4. The Ultimate Cove Corner Tool of claim 1 wherein said tool handle has a non-circular cross-sectional shape.

5. The Ultimate Cove Corner Tool of claim 1 wherein said tool handle has a generally rectangular cross-shape with a threaded female receptacle—adapted end for a paint pole to assist in reaching the ceiling or higher areas with the same handle.

6. The Ultimate Cove Corner Tool of claim 1 wherein said tool head is formed from an elastomer material.

7. The Ultimate Cove Corner Tool of claim 1 wherein said tool head has a diametric size from about 2 inches to about 4 inches.
